(19) United States
(12) Patent Application Publication
(10) Pub. No.: US 2005/0073610 A1
(43) Pub. Date: Apr. 7, 2005

(54) Receiver and video display device

(75) Inventors: Hitoshi Akiyama, Yokohama (JP); Isao Hoda, Fujisawa (JP)

Correspondence Address: McDermott, Will & Emery, 600 13th Street, N.W., Washington, DC, 20005-3096, US

(73) Assignee: Hitachi, Ltd.

(21) Appl. No.: 10/619,493

(22) Filed: Jul. 16, 2003

(30) Foreign Application Priority Data
Mar. 10, 2003 (JP) 2003-062643

(51) Int. Cl. H04N 5/44

(52) U.S. Cl. 348/705; 348/725

(57) ABSTRACT

A single common primary demodulation circuit receives either a terrestrial broadcast or a CATV broadcast. When a CATV broadcast is received, a distribution circuit supplies the input radio frequency to both a primary channel selection circuit and a secondary channel selection circuit for FDC. The distributed signal inputs are demodulated by the primary demodulation circuit and a secondary demodulation circuit, respectively. When a terrestrial broadcast is received, the input radio frequency signal is directly input to the primary channel selection circuit without being passed through the distribution circuit and demodulated by the primary demodulation circuit, thus avoiding signal reduction caused by the distribution circuit.

### BACKGROUND OF THE INVENTION

In recent years, efforts have been made to digitize terrestrial TV broadcasts and CATV (Cable Television) broadcasts. In the field of digital terrestrial TV broadcasting, modulation methods such as 8 VSB (Vestigial Side Band) and OFDM (Orthogonal Frequency Division Multiplexing) are currently used. 8 VSB is adopted in the United States, while OFDM is used in Japan and Europe. Digital CATV broadcasting, on the other hand, uses QAM (Quadrature Amplitude Modulation) as its modulation method. Thus, the terrestrial broadcasting and the CATV broadcasting employ different modulation methods. Japanese Patent Laid-Open No. 11-355681, for example, discloses a technique for providing a receiver commonly used for both terrestrial and CATV broadcasts and including a demodulation circuit for demodulating these broadcasts.

As in the prior art, use of a demodulation circuit capable of demodulating terrestrial and CATV broadcasts makes it possible to provide a TV receiver which can receive these broadcasts.

### SUMMARY OF THE INVENTION

The present invention relates to a TV receiver capable of receiving TV broadcast waves transmitted from a plurality of types of broadcasting systems.

The current trend in digital CATV technology is to establish a standard for a system for transmitting/receiving additional information through a subchannel called OOB (Out Of Band) having a specific frequency in addition to the FAT (Forward Application Transport) channel on which conventional TV signals including video/audio signals are transmitted, as well as putting the system into practical use. In this case, the transmitting station transmits additional information such as encryption information about the FAT channel through a channel called FDC (Forward Data channel), while the receiver transmits receiver information, etc. to the transmitting station through a channel called RDC (Return Data channel). Since the modulation method for FDC uses QPSK (Quadrature Phase Shift Keying), a QPSK receiving circuit for FDC is required separately from the QAM receiving circuit for FAT.

In the case of CATV broadcasting, the signal level of the radio frequency signal is controlled by the CATV provider such that a sufficient margin is provided to avoid causing any problems in demodulation. Accordingly, even when the distribution circuit distributes the radio frequency signal (equally) to the demodulation circuit and the FDC demodulation circuit in the receiver and therefore the signal levels of the signals input to these circuits are 3 dB lower than that of the original signal, no problem arises in demodulation since a sufficient signal level is ensured for it.

In the case of terrestrial broadcasting, on the other hand, various reception environments exist, making it necessary to (properly) receive even a weak electric field. In a strong field strength environment, even when the distribution circuit distributes the radio frequency signal to the two circuits, as in the above CATV reception, and therefore the signal level of the signal input to the channel selection circuit is 3 dB lower than that of the original signal, the level of the signal input to the demodulation circuit is maintained at an appropriate value through the amplification action of the channel selection circuit. In a weak field strength environment, however, the level of the signal input to the demodulation circuit is reduced by 3 dB since there is a limit to the amplifying capability of the channel selection circuit, reducing the reception performance of the demodulation circuit.

As described above, use of a single common TV receiver to receive both a terrestrial broadcast and a CATV broadcast using FDC leads to a reduction in performance in terms of receiving a weak electric field when a terrestrial broadcast is received.

It is, therefore, an object of the present invention to provide a TV receiver capable of receiving both a terrestrial broadcast and a CATV broadcast supporting FDC without reducing the performance in terms of receiving a weak electric field when a terrestrial broadcast is received.

To solve the above problems, a receiver of the present invention comprises: an input unit capable of receiving a first signal and a second signal, the first signal being a signal of a broadcast of a first system, the second signal being a signal of a broadcast of a second system and including additional information; primary channel selector/demodulator for selecting channels for the received first and second signals and demodulating the received first and second signals; secondary channel selector/demodulator for selecting a channel for an additional information signal included in the received second signal and demodulating the additional information signal; and distributor for distributing the received first and second signals to the primary channel selector/demodulator and the secondary channel selector/demodulator; wherein: when the first signal is received by the input unit, the received first signal is input to the primary channel selector/demodulator without being passed through the distributor; and when the second signal is received by the input unit, the received second signal is distributed by the distributor such that it is input to both the primary channel selector/demodulator and the secondary channel selector/demodulator.

With the above arrangement, the signal is not passed through the distribution circuit when a terrestrial broadcast is received. Therefore, the levels of the signals input to the primary channel selection circuit and the primary demodulation circuit are not reduced even in a weak field strength environment, exhibiting no reduction in performance in terms of receiving a weak electric field. When a CATV broadcast is received, the distribution circuit distributes the signal to the primary demodulation circuit and the secondary demodulation circuit for FDC, making it possible to handle CATV broadcasts using FDC.

### BRIEF DESCRIPTION OF THE DRAWINGS

These and other features, objects, and advantages of the present invention will become apparent from the following description when taken in conjunction with the accompanying drawings wherein:

FIG. 1 is a diagram showing a first embodiment of the present invention;

FIG. 2 is a diagram showing a second embodiment of the present invention;

FIG. 3 is a diagram showing a third embodiment of the present invention;

FIG. 4 is a diagram showing a fourth embodiment of the present invention; and

FIG. 5 is a diagram showing a fifth embodiment of the present invention.

### DETAILED DESCRIPTION OF PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications as fall within the ambit of the appended claims.

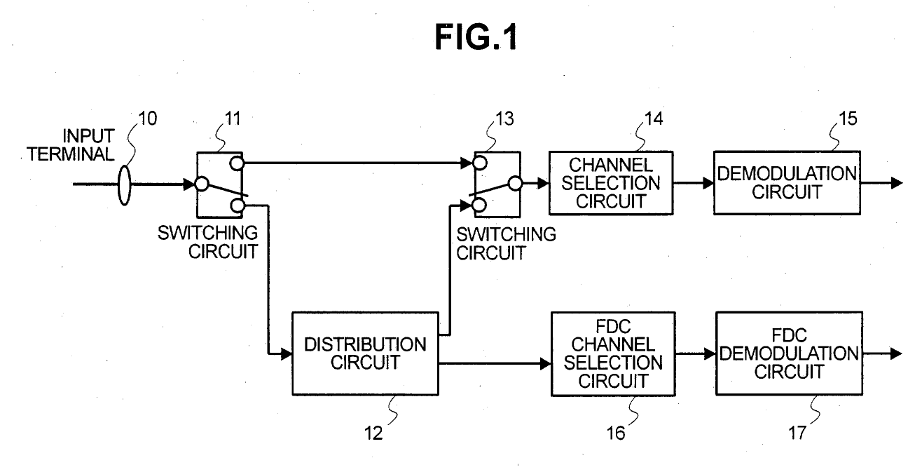

Preferred embodiments of the present invention will be described with reference to the accompanying drawings. It should be noted that the components common to these drawings are denoted by like numerals. FIG. 1 is a block diagram showing a TV receiver according to a first embodiment of the present invention.

Referring to FIG. 1, reference numeral 10 denotes an input terminal; 11 a first switching circuit; 12 a distribution circuit; 13 a second switching circuit; 14 a channel selection circuit; 15 a demodulation circuit; 16 an FDC channel selection circuit; and 17 an FDC demodulation circuit.

The input terminal 10 receives radio frequency signals of a terrestrial broadcast or a CATV broadcast. The radio frequency signals of the CATV broadcast include a FAT channel having a wide bandwidth and an FDC having a narrow bandwidth.

First, description will be made of the operation performed when a CATV broadcast is received. The radio frequency signal input to the input terminal 10 is input to the first switching circuit 11. The switching circuit 11 outputs the radio frequency signal to either the second switching circuit 13 or the distribution circuit 12. Specifically, when a CATV broadcast is received, the first switching circuit 11 outputs the input radio frequency signal to the distribution circuit 12. The distribution circuit 12 distributes the radio frequency signal input from the switching circuit 11 (equally) to the switching circuit 13 and the FDC channel selection circuit 16. At that time, the levels of the radio frequency signals input to the switching circuit 13 and the FDC channel selection circuit 16 are 3 dB lower than that of the radio frequency signal input to the input terminal 10. The switching circuit 13 receives two radio frequency signals, one each from the switching circuit 11 and the distribution circuit 12, and selects one or the other radio frequency signal and outputs it to the channel selection circuit 14. Specifically, when a CATV broadcast is received, the switching circuit 13 outputs the radio frequency signal input from the distribution circuit 12 to the channel selection circuit 14. The channel selection circuit 14 selects a channel from the input radio frequency signal based on the channel frequency of the CATV broadcast and outputs it to the demodulation circuit 15. It should be noted that since the channel bandwidth of the terrestrial broadcast is equal to that of the FAT channel of the CATV broadcast, a single channel selection circuit 14 can be commonly used to receive both types of broadcasts.

Furthermore, the signal to be output to the demodulation circuit 15 is either an intermediate frequency signal or a baseband signal, whichever the demodulation circuit 15 supports. The demodulation circuit 15 supports the demodulation of modulated signals of both the terrestrial broadcast and the FAT channel of the CATV broadcast. In the United States, for example, the demodulation circuit 15 is designed to be able to demodulate 8 VSB signals for terrestrial broadcasting and QAM signals for CATV broadcasting. Therefore, when a CATV broadcast is received, the QAM signal is demodulated to output a digital TV signal.

On the other hand, the FDC channel selection circuit 16 selects a channel from the radio frequency signal distributed from the distribution circuit 12 to the FDC channel selection circuit 16 based on the FDC frequency and outputs it to the FDC demodulation circuit 17. The FDC demodulation circuit 17 carries out demodulation corresponding to the employed FDC modulation method (for example, QPSK demodulation) and outputs the additional information.

Description will be made below of the operation performed when a terrestrial broadcast is received. The radio frequency signal input to the input terminal 10 is input to the first switching circuit 11, as in the above case where a CATV broadcast is received. For reception of the terrestrial broadcast, the switching circuit 11 outputs the input radio frequency signal to the switching circuit 13. The switching circuit 13 outputs the radio frequency signal received from the switching circuit 11 to the channel selection circuit 14. Thus, the signal does not go through the distribution circuit 12, unlike the case where a CATV broadcast is received. Therefore, a radio frequency signal whose signal level is equal to that of the radio frequency signal input to the input terminal 10 is input to the channel selection circuit 14. The channel selection circuit 14 selects the channel for the terrestrial broadcast from the input radio frequency signal and outputs it to the demodulation circuit 15. In the United States, for example, the demodulation circuit 15 demodulates the 8 VSB signal for the terrestrial broadcast to output a digital TV signal.

It should be noted that the distribution circuit 12, the FDC channel selection circuit 16, and the FDC demodulation circuit 17 do not perform any operation since no signal corresponding to FDC is used for reception of a terrestrial broadcast. As described above, when a CATV broadcast is received, the radio frequency signal can be distributed by the distribution circuit 12 to receive the FAT channel and the FDC channel at the same time and thereby obtain their service. When a terrestrial broadcast is received, on the other hand, the radio frequency signal does not go through the distribution circuit 12 and therefore the level of the signal input to the channel selection circuit 14 is not reduced, making it possible to prevent the reduction in the reception performance due to the distribution circuit 12 even in a weak field strength environment in which the level of the radio frequency signal input to the input terminal 10 is low.

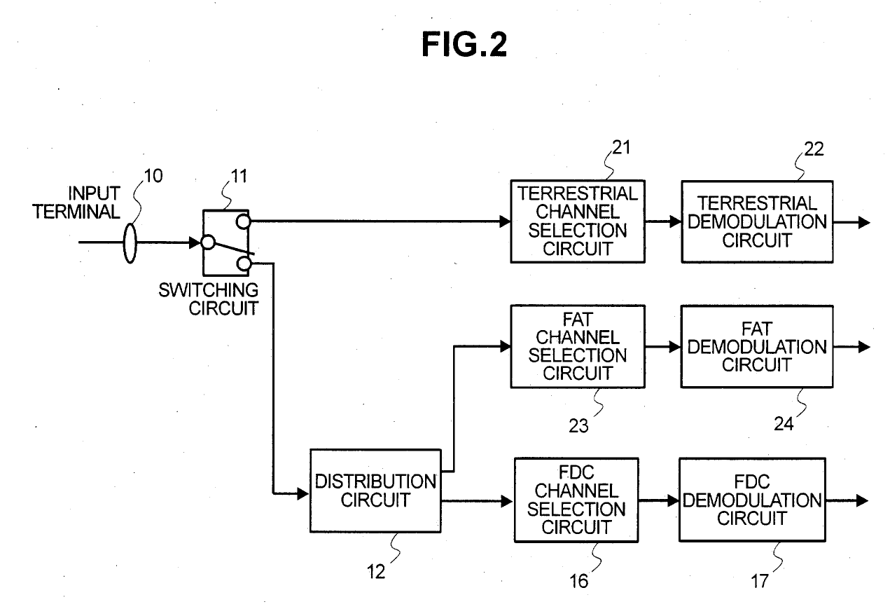

Description will made below of a TV receiver according to a second embodiment of the present invention with reference to FIG. 2. Referring to FIG. 2, reference numeral 21 denotes a terrestrial channel selection circuit; 22 a terrestrial demodulation circuit; 23 a FAT channel selection circuit; and 24 a FAT demodulation circuit.

The first embodiment commonly uses the channel selection circuit 14 and the demodulation circuit 15 to receive both terrestrial and CATV broadcasts. However, circuits dedicated to each broadcast type may be employed as shown in FIG. 2.

When a CATV broadcast is received, the switching circuit 11 outputs the input radio frequency signal to the distribution circuit 12. The distribution circuit 12 distributes the radio frequency signal input from the switching circuit 11 (equally) to the FAT channel selection circuit 23 and the FDC channel selection circuit 16. The FAT channel selection circuit 23 selects the FAT channel of the CATV broadcast from the input radio frequency signal and outputs it to the FAT demodulation circuit 24. The FAT demodulation circuit 24 demodulates the QAM signal to output a digital TV signal. The FDC channel selection circuit 16 and the FDC demodulation circuit 17 perform FDC-channel selection and demodulation, respectively, to output additional information, as in the example shown in FIG. 1.

When a terrestrial broadcast is received, on the other hand, the switching circuit 11 outputs the input radio frequency signal to the terrestrial channel selection circuit 21. Thus, the signal does not go through the distribution circuit 12, unlike the case where a CATV broadcast is received. Therefore, a radio frequency signal whose signal level is equal to that of the radio frequency signal input to the input terminal 10 is input to the terrestrial channel selection circuit 21. The terrestrial channel selection circuit 21 selects the channel for the terrestrial broadcast from the input radio frequency signal. In the United States, for example, the terrestrial demodulation circuit 22 demodulates an 8 VSB signal to output a digital TV signal. It should be noted that when a terrestrial broadcast is received, the distribution circuit 12 and the circuits at the subsequent stages do not perform any operation.

As described above, when a CATV broadcast is received, the radio frequency signal can be distributed by the distribution circuit 12 to receive the FAT channel and the FDC channel at the same time and thereby obtain their service. When a terrestrial broadcast is received, on the other hand, the input radio frequency signal is directly input to the terrestrial channel selection circuit 21 and therefore the signal level is not reduced, making it possible to prevent the reduction in the reception performance due to the distribution circuit 12 in a weak field strength environment.

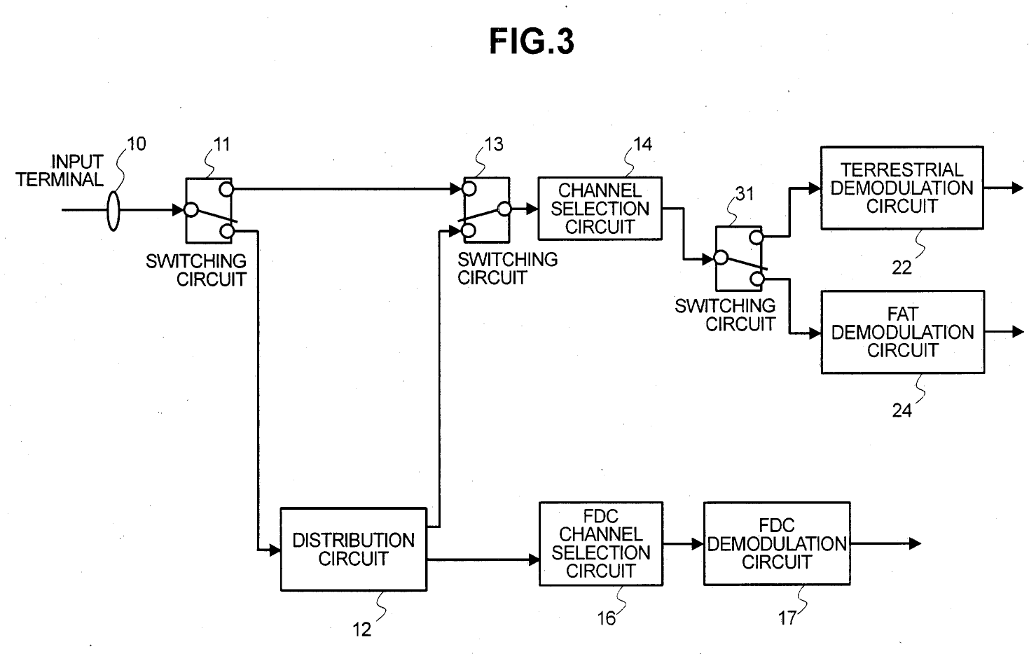

The second embodiment shown in FIG. 2 employs different channel selection circuits and different demodulation circuits to receive terrestrial and CATV broadcasts. However, an arrangement in which a single common channel selection circuit and different demodulation circuits are connected may be employed to receive the terrestrial and CATV broadcasts, as in the third embodiment shown in FIG. 3. Referring to FIG. 3, reference numeral 31 denotes a third switching circuit.

When a CATV broadcast is received, the switching circuit 11 outputs the input radio frequency signal to the distribution circuit 12. The distribution circuit 12 distributes the radio frequency signal input from the switching circuit 11 (equally) to the switching circuit 13 and the FDC channel selection circuit 16. The switching circuit 13 selects the signal from the distribution circuit 12 and outputs it to the channel selection circuit 14. The channel selection circuit 14 selects the FAT channel of the CATV broadcast from the input radio frequency signal and outputs it to the switching circuit 31. The switching circuit 31 outputs the signal from the channel selection circuit 14 to either the terrestrial demodulation circuit 22 or the FAT demodulation circuit 24. Specifically, when a CATV broadcast is received, the switching circuit 31 outputs the signal to the FAT demodulation circuit 24. The FAT demodulation circuit 24 demodulates, the QAM signal to output a digital TV signal. The FDC channel selection circuit 16 and the FDC demodulation circuit 17 perform FDC-channel selection and demodulation, respectively, to output additional information, as in the example shown in FIG. 1.

When a terrestrial broadcast is received, the switching circuit 11 outputs the input radio frequency signal to the switching circuit 13. The switching circuit 13 selects the radio frequency signal from the switching circuit 11 and outputs it to the channel selection circuit 14. Thus, the signal does not go through the distribution circuit 12, unlike the case where a CATV broadcast is received. Therefore, a signal whose signal level is equal to that of the radio frequency signal input to the input terminal 10 is input to the channel selection circuit 14. The channel selection circuit 14 selects the channel for the terrestrial broadcast from the input radio frequency signal and outputs it to the switching circuit 31. The switching circuit 31 switches to the terrestrial demodulation circuit 22 and thereby outputs the signal on the selected channel to the terrestrial demodulation circuit 22, which then demodulates the 8 VSB signal to output a digital TV signal. It should be noted that when a terrestrial broadcast is received, the distribution circuit 12 and the circuits at the subsequent stages do not perform any operation.

As described above, when a CATV broadcast is received, the radio frequency signal can be distributed by the distribution circuit 12 to receive the FAT channel and the FDC channel at the same time and thereby obtain their service. When a terrestrial broadcast is received, on the other hand, the input radio frequency signal is directly input to the channel selection circuit 14, making it possible to prevent the reduction of the signal level and thereby prevent the reduction of the reception performance even in a weak field strength environment.

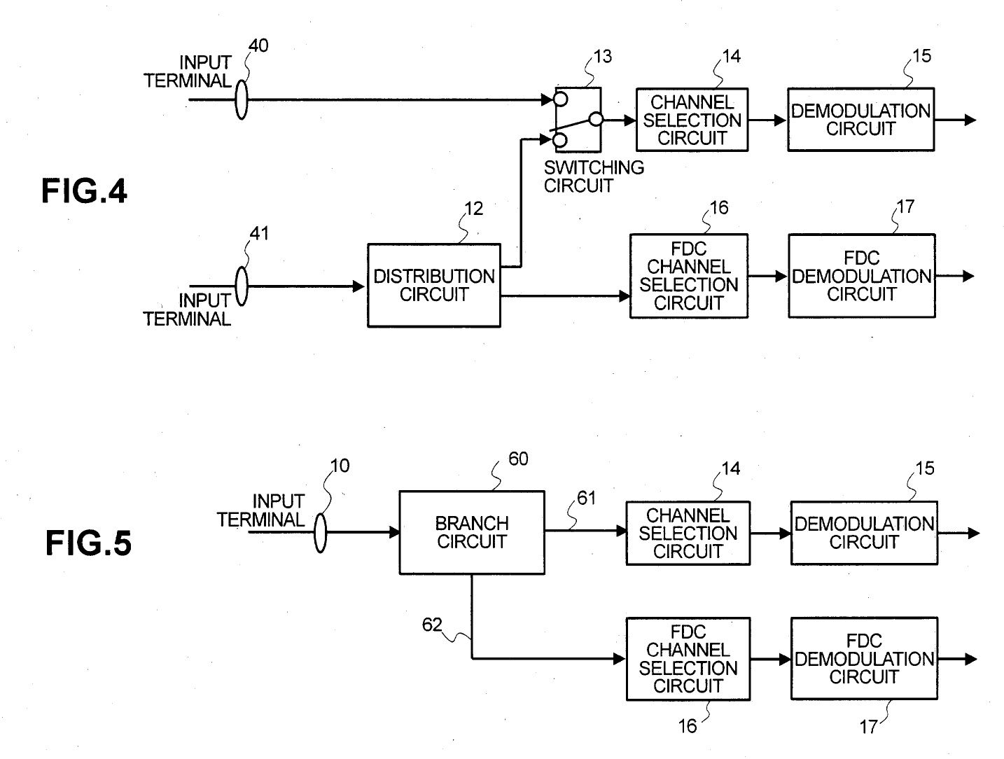

The above embodiments employ only one input terminal, to which the radio frequency signals of both a terrestrial broadcast and a CATV broadcast are input. However, two input terminals may be employed, one each for terrestrial and CATV broadcasts, while using a common channel selection circuit and a common demodulation circuit. Also in this case, it is possible to prevent reduction of the reception performance when a terrestrial broadcast is received. Description will be made of an example of the above arrangement (a fourth embodiment) with reference to FIG. 4.

Referring to FIG. 4, reference numeral 40 denotes a radio frequency signal input terminal for terrestrial broadcasts, and 41 denotes a radio frequency signal input terminal for CATV broadcasts. These terminals constantly receive respective radio frequency signals. The radio frequency signal of a terrestrial broadcast from the input terminal 40 is input to the switching circuit 13. The radio frequency signal of a CATV broadcast from the input terminal 41 is input to the distribution circuit 12, which then distributes the signal to the switching circuit 13 and the FDC channel selection circuit 16.

When a CATV broadcast is received, the switching circuit 13 selects the radio frequency signal from the distribution circuit 12 and outputs it to the channel selection circuit 14. The channel selection circuit 14 selects the FAT channel of the CATV broadcast from the input radio frequency signal and outputs it to the demodulation circuit 15. The demodulation circuit 15 demodulates the QAM signal to output a digital TV signal. The FDC channel selection circuit 16 and the FDC demodulation circuit 17 perform FDC-channel selection and demodulation, respectively, to output additional information, as in the example shown in FIG. 1.

When a terrestrial broadcast is received, on the other hand, the switching circuit 13 selects the input radio frequency signal from the input terminal 40 and outputs it to the channel selection circuit 14. Thus, the signal does not go through the distribution circuit 12, unlike the case where a CATV broadcast is received. Therefore, the input radio frequency signal to the input terminal 10 is directly input to the channel selection circuit 14. The channel selection circuit 14 selects the channel for the terrestrial broadcast from the input radio frequency signal and outputs it to the demodulation circuit 15. The demodulation circuit 15 demodulates the 8 VSB signal to output a digital TV signal. It should be noted that when a terrestrial broadcast is received, the distribution circuit 12 and the circuits at the subsequent stages do not perform any operation.

As described above, when a CATV broadcast is received, the radio frequency signal can be distributed by the distribution circuit 12 to receive the FAT channel and the FDC channel at the same time and thereby obtain their service. When a terrestrial broadcast is received, on the other hand, the input radio frequency signal is directly input to the channel selection circuit. 14, making it possible to prevent the reduction of the signal level and thereby prevent the reduction of the reception performance even in a weak field strength environment. This arrangement allows reducing the device cost and increasing the video quality.

It should be noted that the switching circuits of the above embodiments perform switching operation based on the type of the radio frequency signal input to the input terminal 10. Whether the input radio frequency signal is of a terrestrial broadcast or CATV broadcast may be determined by letting the user specify the receiving signal type or using the demodulation result of the demodulation circuit 15. Furthermore, it is possible to indicate whether the signal is of a terrestrial broadcast or CATV broadcast on the display screen based on the above specification or demodulation result (OSD: On Screen Display).

Further, description will be made of a fifth embodiment of the present invention which employs a branch circuit with reference to FIG. 5. Since the distribution circuits in the above embodiments distribute the signal equally to the subsequent two circuits, the loss (ratio) of the output to the input is 3 dB, assuming that there is no circuit loss. The branch circuit 60 of the present embodiment, on the other hand, branches the signal so as to extract only a (small) portion of the signal; most of the input radio frequency power appears as “passage output” 61 and a (small) portion of the power is extracted as branch output 62.

The level difference between the input level of the branch circuit 60 and the signal level of the passage output 61 is referred to as insertion loss, and the insertion loss is dependent on the power of the branch output 62. Decreasing the power of the branch output 62 reduces the insertion loss, which increases the power of the passage output 61.

It should be noted that since a QPSK modulation method is used for FDC, the required CN is relatively small. Furthermore, since the signal level is controlled such that it is kept constant, reducing the power of the branch output 62 of the branch circuit does not affect the reception. Therefore, when a CATV broadcast is received, both the FAT channel and the FDC can be received without any problem.

The signal is also branched by the branch circuit 60 when a terrestrial broadcast is received. However, it is arranged such that the power of the branch output 62 is small and the power of the passage output 61 is large, making it possible to reduce the decrease in the signal level of the passage output 61 to the channel selection circuit 14. With this arrangement, it is possible to reduce the rise of the lower field strength limit for reception of terrestrial broadcasts, as compared with above examples using a distribution circuit. Furthermore, a switching circuit, etc. are not required, resulting in reduced cost.

The receivers described above select a channel for terrestrial or CATV broadcast signals, demodulate the signals, and perform decode processing, etc. on the demodulated digital signals before outputting the signals to a display apparatus, etc. (not shown) as video, audio, etc. The present invention may be configured as a tuner unit incorporating a display apparatus such as a plasma display or a liquid crystal display.

Thus, the present invention provides arrangements which make it possible to receive TV signals for a plurality of systems, resulting in low costs.

1. A receiver comprising:
an input unit capable of receiving a first signal and a second signal, said first signal being a signal of a broadcast of a first system, and second signal being a signal of a broadcast of a second system and including additional information;
a primary channel selector/demodulator which selects channels for said received first and second signals and demodulates said received first and second signals;
a secondary channel selector/demodulator which-selects a channel for an additional information signal included in said received second signal and demodulates said additional information signal; and
a distributor which distributes said received first and second signals to said primary channel selector/demodulator and said secondary channel selector/demodulator; wherein:
when said first signal is received by said input unit, said received first signal is input to said primary channel selector/demodulator without being passed through said distributor; and
when said second signal is received by said input unit, said received second signal is distributed by said distributor such that it is input to both said primary channel selector/demodulator and said secondary channel selector/demodulator.

2. The receiver as claimed in claim 1, wherein:
said broadcast of said first system comprises a terrestrial broadcast modulated in accordance with an 8 VSB scheme or an OFDM scheme; and
said broadcast of said first system comprises a CATV broadcast modulated in accordance with a QAM scheme.

3. The receiver as claimed in claim 1, wherein said primary channel selector/demodulator includes a demodulation circuit capable of demodulating both a terrestrial broadcast signal modulated in accordance with an 8 VSB scheme or an OFDM scheme and a CATV broadcast signal modulated in accordance with a QAM scheme.

4. The receiver as claimed in claim 1, wherein said primary channel selector/demodulator includes a first demodulation circuit for demodulating a terrestrial broadcast signal demodulated in accordance with an 8 VSB scheme or an OFDM scheme and a second demodulation circuit for demodulating a CATV broadcast signal modulated in accordance with a QAM scheme.

5. The receiver as claimed in claim 2, wherein said additional information includes encryption information on a CATV broadcast signal.

6. The receiver as claimed in claim 1, wherein said secondary channel selector/demodulator includes a QPSK demodulator for demodulating said additional information.

7. The receiver as claimed in claim 1, wherein said input unit comprises:
a switch which switches between said distributor and said primary channel selector/demodulator so as to selectively input a signal received by said input unit to said distributor and said primary channel selector.

8. The receiver as claimed in claim 1, further comprising:
a switch which switches between an input signal from said input unit and a signal from said distributor so as to input one or the other signal to said primary channel selector/demodulator.

9. The receiver as claimed in claim 2, wherein:
said input unit includes a first input unit and a second input unit;
a terrestrial broadcast signal received by said first input unit is input to said primary channel selector/demodulator; and
a CATV broadcast signal received by said second input unit is input to said distributor.

10. The receiver as claimed in claim 1, wherein said primary channel selector/demodulator includes:
a first primary channel selector/demodulator which selects a channel for said first signal and demodulates said first signal; and
a second primary channel selector/demodulator which selects a channel for said second signal and demodulates said second signal.

11. A video display device comprising:
the receiver as claimed in claim 1; and
a display for decoding a signal demodulated by said receiver and displaying it as video, a channel for said demodulated signal being selected by said receiver.

12. The video display device as claimed in claim 11, wherein said video display device identifies a broadcast system through user operation or automatically and indicates it on said display.

13. A receiver capable of receiving a first signal and a second signal, said first signal being a signal of a broadcast of a first system, said second signal being a signal of a broadcast of a second system and including additional information, comprising
a primary channel selector/demodulator which selects channels for said received first and second signals and demodulates said received first and second signals;
a secondary channel selector/demodulator which selects a channel for an additional information signal included in said received second signal and demodulating said additional information signal; and
a branch circuit which distributes said received first and second signals to said primary channel selector/demodulator and said secondary channel selector/demodulator;
wherein when said first signal or said second signal is received, said branch circuit distributes it to said primary channel selector/demodulator and said secondary channel selector/demodulator such that power of a signal input to said primary channel selector/demodulator is larger than power of a signal input to said secondary channel selector/demodulator.

14. The receiver as claimed in claim 13, wherein:
said broadcast of said first system comprises a terrestrial broadcast modulated in accordance with an 8 VSB scheme or an OFDM scheme; and
said broadcast of said second system comprises a CATV broadcast modulated in accordance with a QAM scheme.

15. The receiver as claimed in claim 13, wherein said primary channel selector/demodulator includes a demodulation circuit capable of demodulating both a terrestrial broadcast signal modulated in accordance with an 8 VSB scheme or an OFDM scheme and a CATV broadcast signal modulated in accordance with a QAM scheme.

16. The receiver as claimed in claim 13, wherein said primary channel selector/demodulator includes a first demodulation circuit for demodulating a terrestrial broadcast signal demodulated in accordance with an 8 VSB scheme or an OFDM scheme and a second demodulation circuit for demodulating a CATV broadcast signal modulated in accordance with a QAM scheme.

17. The receiver as claimed in claim 14, wherein said additional information includes encryption information on a CATV broadcast signal.

18. The receiver as claimed in claim 13, wherein said secondary channel selector/demodulator includes a QPSK demodulator which demodulates said additional information.

19. A video display device comprising:
the receiver as claimed in claim 13; and
a display for decoding a signal demodulated by said receiver and displaying it as video, a channel for said demodulated signal being selected by said receiver.

20. The video display device as claimed in claim 19, wherein said video display device identifies a broadcast system through user operation or automatically and indicates it on said display.
